(19) United States
(12) Patent Application Publication
(10) Pub. No.: US 2013/0014593 A1
(43) Pub. Date: Jan. 17, 2013

(54) PRESSURE GUIDING TUBE BLOCKAGE DETECTING SYSTEM AND DETECTING METHOD

(71) Applicants: Tetsuya Tabaru, Tokyo (JP); Naoyuki Aota, Tokyo (JP)

(72) Inventors: Tetsuya Tabaru, Tokyo (JP); Naoyuki Aota, Tokyo (JP)

(73) Assignee: AZBIL CORPORATION

(21) Appl. No.: 13/545,753

(22) Filed: Jul. 10, 2012

(30) Foreign Application Priority Data
Jul. 15, 2011 (JP) 2011-156422

(51) Int. Cl. G01F 1/34

(52) U.S. Cl. 73/861.42

(57) ABSTRACT

A vessel is attached to a pressure guiding tube near the point of connection between a process pipe and a pressure transmitter. Doing so increases the rate of deformation, relative to a change in pressure, of a fluid when the fluid is a compressible fluid, making the change in the pressure fluctuation more easily detected, thereby increasing the sensitivity of detection of blockages in the pressure guiding tube. If the fluid is a non-compressible fluid, then a part that has a diaphragm (a pressure bearing surface that deforms easily through pressure) is connected instead of the vessel.

### CROSS REFERENCE TO RELATED APPLICATIONS

The present application claims priority under 35 U.S.C. §119 to Japanese Patent Application No. 2011-156422, filed Jul. 15, 2011, which is incorporated herein by reference.

### FIELD OF TECHNOLOGY

The present invention relates to a pressure guiding tube blockage detecting system and detecting method for detecting a blockage that has occurred in a pressure guiding tube that branches from a process pipe.

### BACKGROUND

Conventionally, pressure transmitting devices and differential pressure transmitting devices have been used in the process industry in order to control processes wherein, for example, process variable quantities are detected. A pressure transmitter is also known as a pressure transmitting device, and a differential pressure transmitter is also known as a differential pressure transmitting device. The pressure transmitter measures an absolute pressure or a gauge pressure, and the differential pressure transmitter measures a differential pressure between two points, and they are used for measuring process variable quantities such as pressure, flow rate, fluid level, specific gravity, and the like. Typically, when a pressure/differential pressure transmitter (hereinafter termed simply a “transmitter” when referred to in general) is used to measure a process variable quantity, where that which is to be measured is directed to the transmitter through a narrow tube, known as a pressure guiding tube, from a process pipe wherein flows the fluid that is to be measured.

FIG. 14 shows a schematic diagram of a system (a pressure measuring system) that uses a pressure transmitter. In this pressure measuring system, a pressure transmitter 1 detects the pressure of a fluid that flows through a pressure guiding tube 3 that branches from a process pipe 2.

FIG. 15 shows a schematic diagram of a system (a differential pressure measuring system) that uses a differential pressure transmitter. In this differential pressure measuring system, a differential pressure transmitter 4 detects a pressure difference in fluids that are directed through pressure guiding tubes 3-1 and 3-2 that branch from the process pipe 2. Note that in this system, a differential pressure generating mechanism (an orifice, or the like) 5 is provided in the process pipe 2, and the pressure guiding tubes 3-1 and 3-2 branch from positions before and after this differential pressure generating mechanism 5.

In such a pressure measuring system structure or differential pressure measuring system structure, the pressure guiding tube may become blocked due to the adhesion, within the pressure guiding tube, of solid material, or the like, depending on that which is being measured. When a pressure guiding tube becomes blocked completely, the impact on the plant may be very large due to the loss of ability to measure accurately the variable quantities in the process. However, because the pressure is conveyed to the transmitter up until the point that the pressure guiding tube becomes completely blocked, the effect of the blockage tends to not appear in the values measured for the process variable quantities.

In response to this problem, a pressure transmitter of a remote seal type, which does not require a pressure guiding tube, has been commercialized. However, there are an extremely large number of plants that measure process variable quantities using pressure guiding tubes, and there are calls for the creation of an online function for detecting blockages in pressure guiding tubes.

In response to this issue, means and devices for detecting blockages in pressure guiding tubes using fluctuations in the pressures of fluids have been proposed already.

For example, Japanese Examined Patent Application Publication H7-11473 (“JP '473”) discloses that a blockage in a pressure guiding tube can be detected through a decrease in the maximum variation amplitude (the difference between the maximum value and the minimum value) in a pressure signal.

Japanese Patent 3139597 (“JP '597”) and Japanese Patent 3129121 (“JP '121”) disclose devices and methods for detecting blockages in pressure guiding tubes using the magnitudes of fluctuations in pressures or differential pressures, and using parameters that are calculated therefrom.

Japanese Examined Patent Application Publication 2002-538420 (“JP '420”) discloses a device and method for detecting the state of a pressure guiding tube from a statistical quantity or mathematical function that reflects the magnitudes of fluctuations, such as the standard deviation or power spectrum density of the fluctuations, derived from the pressure.

Japanese Unexamined Patent Application Publication 2010-127893 (“JP '893”) discloses a device and method for detecting a blockage from the speed of fluctuations, such as, the frequency of rising/falling movement in the pressure fluctuations. Note that the invention set forth in this JP '893 differs from the inventions set forth in JP '473 , JP '597, JP '121, and JP '420 in the point that it is based on the speed (frequency) of fluctuations, rather than on the amplitude of the fluctuations in the pressure or differential pressure; however it shares the point that the fluctuations in pressure or differential pressure are used.

However, these conventional methods for detecting blockages in pressure guiding tubes using pressure fluctuations have had a problem in that detection is not possible until the degree of blockage (occlusion) has become quite advanced. For example, the relationship between the degree of occlusion and the power spectrum that is the basis for evaluating the blockage is shown in FIG. 4 through FIG. 6 in Japanese Examined Patent Application Publication 2009-505276 (“JP '276”) (although the fluid that is used is not defined as), but the diameters of the holes that are occluded, shown therein, are quite small, at 0.0135 inches (0.34 mm) and 0.005 inches (0.13 mm).

Moreover, in EINO Jyun-ichi, WAKUI Tetsuya, HASHIZUME Takumi, MIYAJI Nobuo, KUROMORI Kenichi, and YUUKI Yoshitaka: “Detection of Impulse Line Blockage with Digital Differential Pressure Transmitter on Water Line,” SICE Trans. on Industrial Application, Volume 6, Number 13, 103/109 (2007), experiments were performed using water as the fluid in a state wherein a needle valve, wherein the rated Cv value is 0.015, was narrowed to 5%, as a dummy occlusion, and it was possible to detect this dummy occlusion. However, the 5% of the Cv value of 0.015 means that when there is a pressure differential of 1 psi (6.895 kPa) across the valve, there would be a fluid flow of 7.5×10⁻⁴ gallons per minute, that is, the flow of only 2.8 mL per minute of fluid. This is the equivalent of the fluid flow characteristics for an occluded tube with a diameter of 0.23 mm and a length of 10 mm (calculated using the Hagen-Poiseuille method), near to the blocked state shown in JP '276.

As described above, the degrees of blockages that are covered by the existing literature are for states wherein the blockages are quite advanced. Given this, it is also difficult to detect blockages that have not advanced that far. This problem is found in all methods that diagnose blockages in pressure guiding tubes using pressure fluctuations, and although there are some small differences, the same problems occur regardless of the method that is used.

Note that it is possible to improve on the degree of occlusion that can be detected through the use of the higher frequency components in the pressure fluctuations. However, because typically the amplitudes of the pressure fluctuations are smaller the higher the frequencies, they are difficult to use. Consequently, the problem has not been easy to solve through the use of the higher frequency components alone.

The present invention solves this type of problem, and the object thereof is to provide a pressure guiding tube blockage detecting system and detecting method able to detect a blockage in a pressure guiding tube at an earlier point in time, through increasing the sensitivity of the pressure guiding tube blockage detection.

### SUMMARY

The examples of the present invention, in order to achieve such an object, is a pressure guiding tube blockage detecting system for detecting a blockage in a pressure guiding tube that branches from a process pipe, having a deformation rate increasing device for increasing a rate of deformation of a tube system relative to a change in pressure, wherein a pressure guiding tube, a connecting tube that is connected to a pressure guiding tube, and a fluid that flows in these tubes are defined as the tube system.

Given this invention, the pressure guiding tube, the connecting tube that connects to the pressure guiding tube, and the fluid that flows through these tubes is defined as a tube system, where the high-frequency components of the pressure fluctuations of the fluid tend to be attenuated through increasing the rate of deformation of this tube system relative to the change in pressure. This makes it easier to detect changes in the pressure fluctuation, increasing the sensitivity of the pressure guiding tube blockage detection, enabling a blockage in the pressure guiding tube to be detected at an earlier point in time.

In the examples of the present invention, the rate of deformation relative to the change in pressure of the fluid in the tube system may be increased when the fluid is a compressible fluid. In this case, one may consider increasing the rate of deformation relative to the change in pressure of the fluid in the tube system through the provision, as a deformation rate increasing device, of a vessel that is filled with the fluid that is introduced through the connecting tube.

In the examples of the present invention, if the fluid is a non-compressible fluid, the rate of deformation, relative to the rate of deformation in pressure, of a surface that contacts the fluid in the tube system may be increased. In this case, one may consider increasing the rate of deformation relative to the change in pressure at the surface that contacts the fluid in the tube system through the provision, as deformation rate increasing device, of a diaphragm that contacts the fluid that is introduced through the connecting tube.

Moreover, the examples of the present invention may be enabled through a pressure guiding tube blockage detecting method instead of a pressure guiding tube blockage detecting system.

The examples of the present invention increases the rate of deformation of the tube system relative to the change in pressure, when a pressure guiding tube, a connecting tube that connects to the pressure guiding tube, and a fluid that flows in these tubes is a tube system, thereby increasing the tendency for the high-frequency component of the pressure fluctuation of the fluid to be attenuated, making it easier to detect changes in the pressure fluctuations, thereby increasing the intensity of the pressure guiding tube blockage detection, making it possible to detect a blockage in a pressure guiding tube at an earlier point in time.

### BRIEF DESCRIPTION OF THE DRAWINGS

FIG. 1 is a diagram illustrating a pressure measuring system when operating normally.

FIG. 2 is a diagram illustrating the pressure measuring system when the pressure guiding tube is blocked.

FIG. 3 is a diagram for explaining the effects of a low-pass filter due to a pressure guiding tube blockage, and explaining the elements relevant thereto.

FIG. 4 is a diagram for explaining the effects of a low-pass filter due to a pressure guiding tube blockage, and deforming elements relating thereto (the pressure bearing surface of the transmitter, the fluid within the pressure guiding tube, the tube walls of the pressure guiding tube, and the like).

FIG. 5 is a diagram for explaining the reason why the detection is made easier through the operation of the deforming element.

FIG. 6 is a diagram for explaining the modeling of the low-pass filter results.

FIG. 7 is a diagram illustrating an example of a guiding tube blockage detecting system according to the present invention.

FIG. 8 is a diagram illustrating another example of a guiding tube blockage detecting system according to the present invention.

FIG. 9 is a graph illustrating a comparison between the blockage indicator when the first example of the first form of embodiment was executed compared with the conventional method.

FIG. 10 is a diagram illustrating a Reference Example wherein the same effects as in the examples are obtained by increasing the volume of the fluid in the interval between the blockage (occlusion) and the pressure transmitter by increasing the inner diameter of part or all of the pressure guiding tube.

FIG. 11 is a diagram illustrating a yet further example of a guiding tube blockage detecting system according to the present invention.

FIG. 12 is a diagram illustrating an example of a guiding tube blockage detecting system according to the present invention.

FIG. 13 is a diagram illustrating another Reference Example wherein the same effects as in the above examples are obtained through the use of materials or structures wherein the pressure guiding tube is easily deformed by changes in pressure.

FIG. 14 is a schematic diagram of a system (a pressure measuring system) that uses the pressure transmitter.

FIG. 15 is a system that uses a differential pressure transmitter (a differential pressure measuring system).

### DETAILED DESCRIPTION

Examples according to the present invention are explained in detail below, based on the drawings. First, prior to entering into an explanation of the examples, the background up until the conception of the present invention, and the principle of the present invention, are explained.

While a variety of detecting methods have been proposed as methods for detecting blockages in pressure guiding tubes using fluctuations in pressure or differential pressure, and while the principle of detection itself is different, the physical phenomenon that is used is the same. That is, the phenomenon wherein a blockage (an occlusion) in the pressure guiding tube acts as a low-pass filter in regards to the propagation of pressure within the pipe.

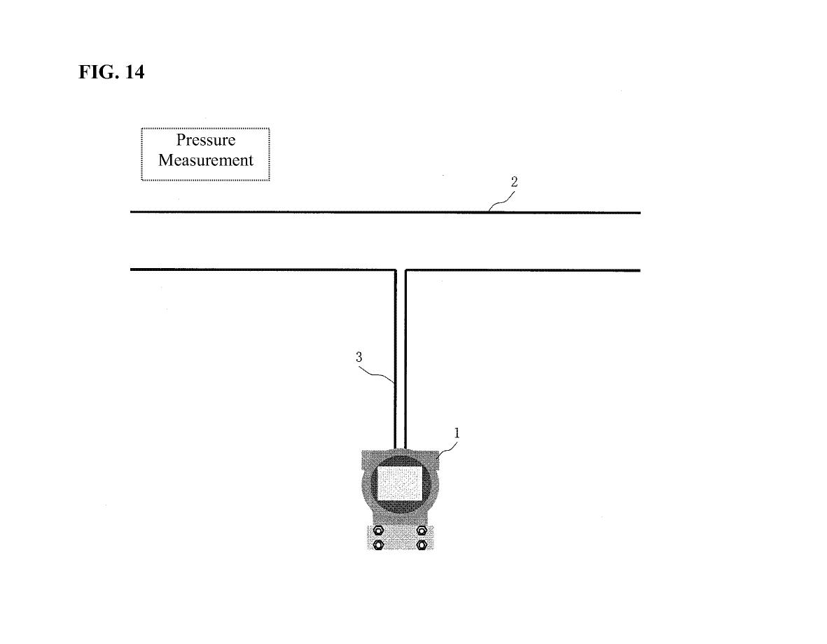

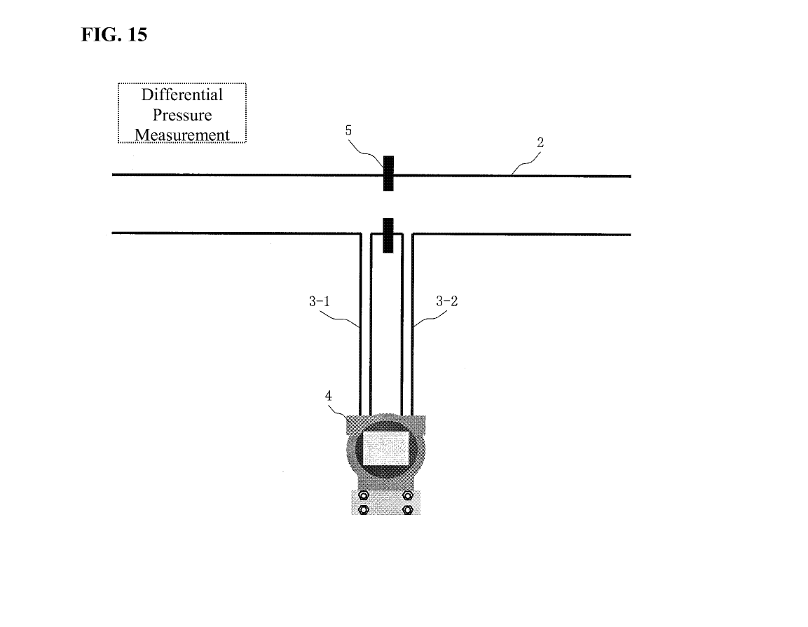

In the below, the pressure measuring system illustrated in FIG. 14 is used as an example. Note that except for there being two pressure guiding tubes in the differential pressure measuring system illustrated in FIG. 15, essentially there is no differences that relate to the examples of the present invention, and thus the explanation uses the pressure measuring system illustrated in FIG. 14 as a representative example.

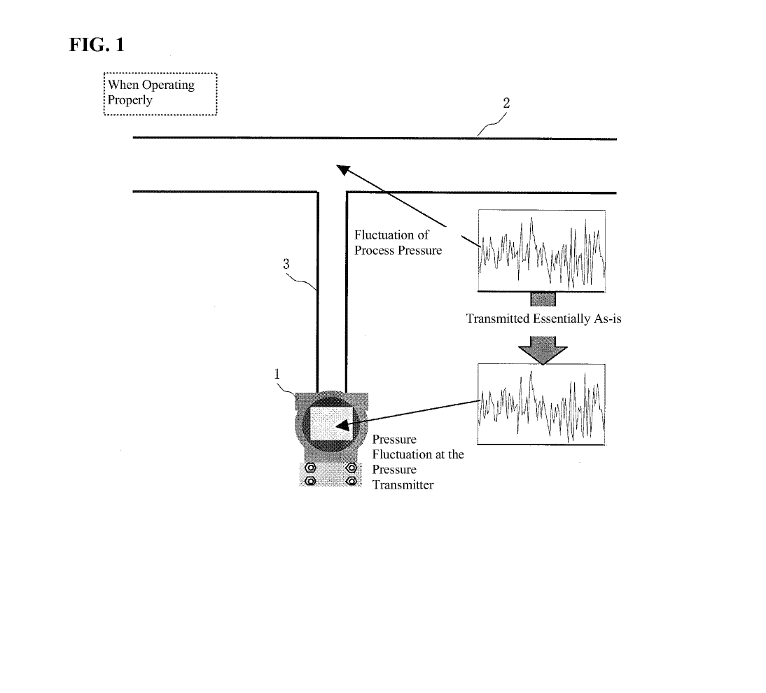

FIG. 1 illustrates the pressure measuring system when operating properly. In this case, there is no blockage in the pressure guiding tube 3, so the fluctuations (the up/down motion) of the pressure in the fluid (the process) within the process pipe 2 is propagated essentially as-is to the pressure transmitter 1, to be a pressure fluctuation at the pressure transmitter 1.

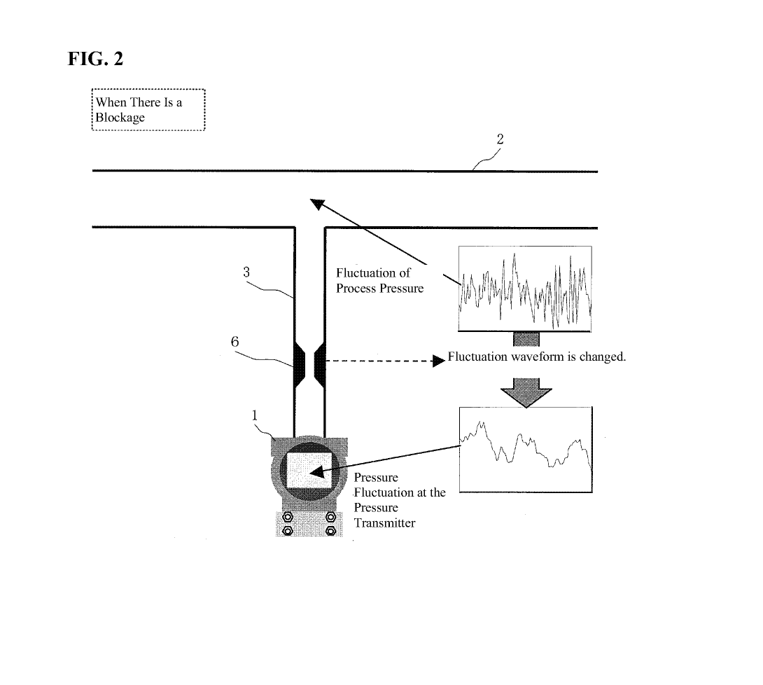

However, as illustrated in FIG. 2, when a blockage (occlusion) 6 occurs in the pressure guiding tube 3, this blockage (occlusion) 6 acts as a low-pass filter when it comes to the propagation of the pressure, so that the pressure fluctuations detected by the pressure transmitter 1 is attenuated relative to the case wherein there is no blockage (occlusion) 6. In particular, the higher the frequency, the greater the degree of attenuation. The blockage in the pressure guiding tube 3 is diagnosed through the change in the amplitudes and in the frequencies of the fluctuations.

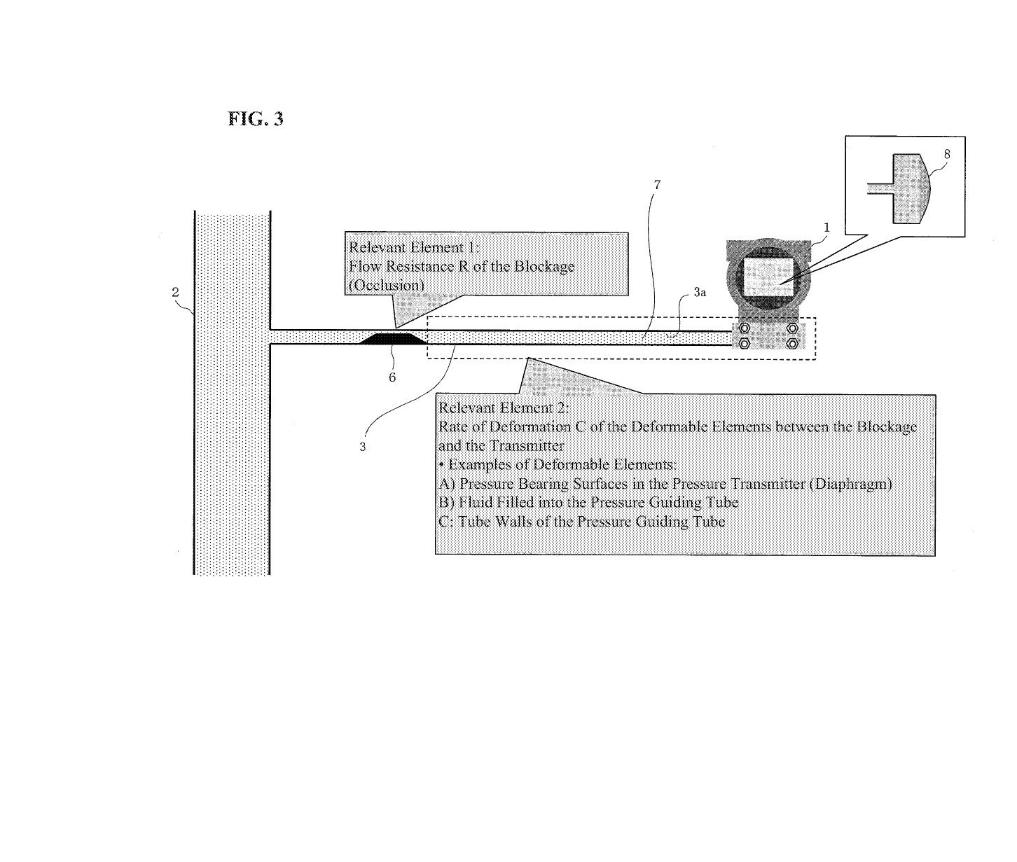

There are two elements involved in this phenomenon (Referencing FIG. 3). The first is, of course, the degree of blockage. The more serious the degree of blockage, the greater the degree to which the high-frequencies are attenuated (in other words, the lower the cutoff high-frequency of the filter).

The other is the rate of deformation, relative to pressure, of the fluid 7 in the pressure guiding tube 3 between the blockage (occlusion) 6 and the pressure transmitter 1, and of the pressure bearing surfaces (the diaphragm within the pressure transmitter 1) 8 of the pressure transmitter 1 that are in contact with the fluid 7, and of the wall surfaces 3a of the pressure guiding tube 3 (which, in the below, will be referred to in combination as the “deforming elements”). The greater this rate of deformation, that is, the greater the total amount of deformation of the deforming elements relative to a unit change in pressure, the greater the tendency for attenuation of the high-frequency component of the fluctuation.

This fact can be used to increase the attenuation of the high-frequency component by intentionally increasing the rate of deformation of the deforming elements relative to changes in pressure, to increase the sensitivity of the pressure guiding tube blockage detection, to detect a blockage in the pressure guiding tube at an earlier point in time.

Of these two elements described above, the former (that is, the degree of blockage) is the exact phenomenon that is being diagnosed, and thus cannot be manipulated, but the latter (the rate of deformation of the deforming elements) can be manipulated intentionally. Consequently, it is possible to increase the sensitivity of the pressure guiding tube blockage detection through manipulation of the rate of deformation of the deforming elements in the direction that increases the attenuation of the high-frequency components. In the below, first an intuitive explanation regarding the principle of the present invention is provided, following which the details thereof is described.

The deforming elements of a pressure guiding tube 3, a pressure bearing surface 8 of a pressure transmitter 1, and a fluid 7 which is the subject of the measurement, exist on the side wherein, when viewed from the blockage (occlusion) 6, there is the pressure transmitter 1 (hereinafter termed the “detecting end side”). These deform to some degree or another when there is a change in pressure within the pipe, and concomitantly, there is also a change in volume of the fluid 7 that exists on the detecting end side when viewed from the blockage (occlusion) 6.

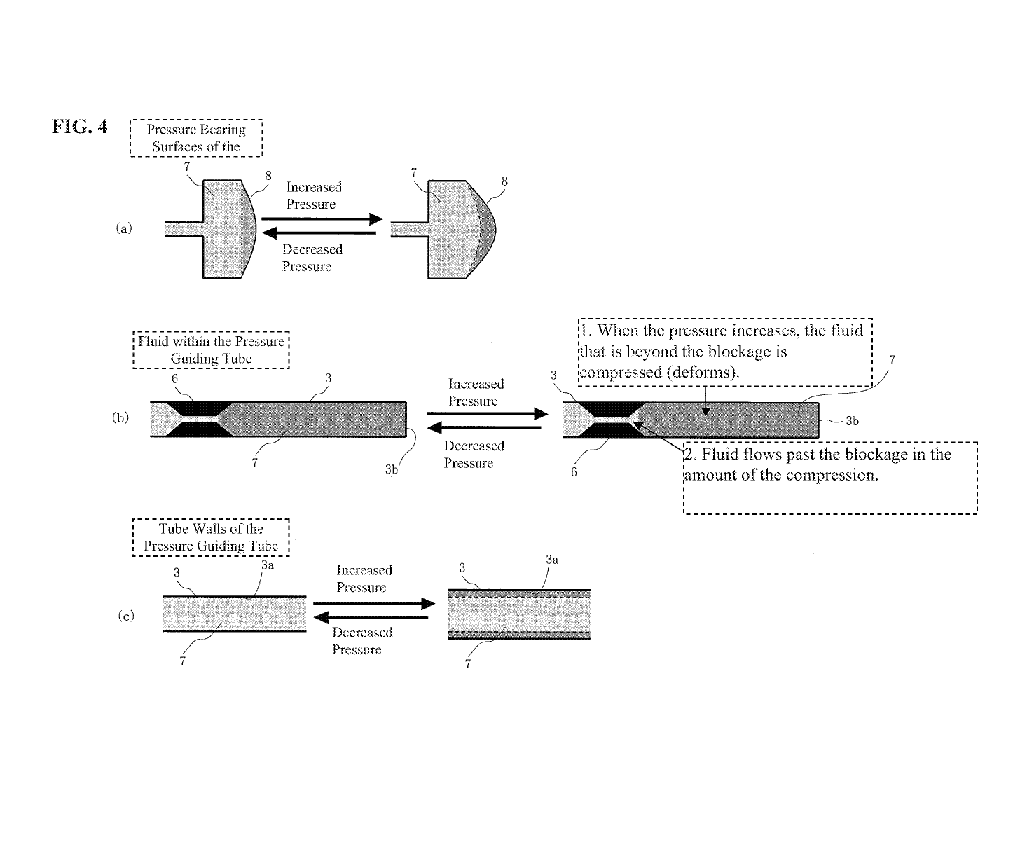

That is, in response to an increase in pressure or decrease in pressure, the pressure bearing surfaces 8 of the pressure transmitter 1 deforms as illustrated in FIG. 4(a), the fluid 7 within the pressure guiding tube 3 deforms as illustrated in FIG. 4(b), and the tube walls 3a of the pressure guiding tube 3 deforms as illustrated in FIG. 4(c), and together with this, the amount of the fluid 7 that exists on the detecting end side when viewed from the blockage (occlusion) 6 also change. The amount of this change is compensated for through the inflow or outflow of fluid through the blockage (occlusion) 6. Note that in FIG. 4(b), 3b is a stationary end of the pressure guiding tube 3.

Here, because the pressure on the process side has changed, there is a pressure differential across the blockage (occlusion) 6. Given this, a flow is produced across the blockage (occlusion) 6 so as to reduce this pressure differential. While this is a flow, the volume of the fluid required in order to cancel this pressure differential is proportional to the ease of deformation of the deforming elements on the detecting end side when viewed from the blockage (occlusion) 6.

The reason for this is that easy deformation thereof by a change in pressure means that changing the pressure on the detecting end side, that is, causing the pressure on the detecting end side to become equal to that on the process pipe side, requires a greater deformation, requiring more fluid to flow in or flow out.

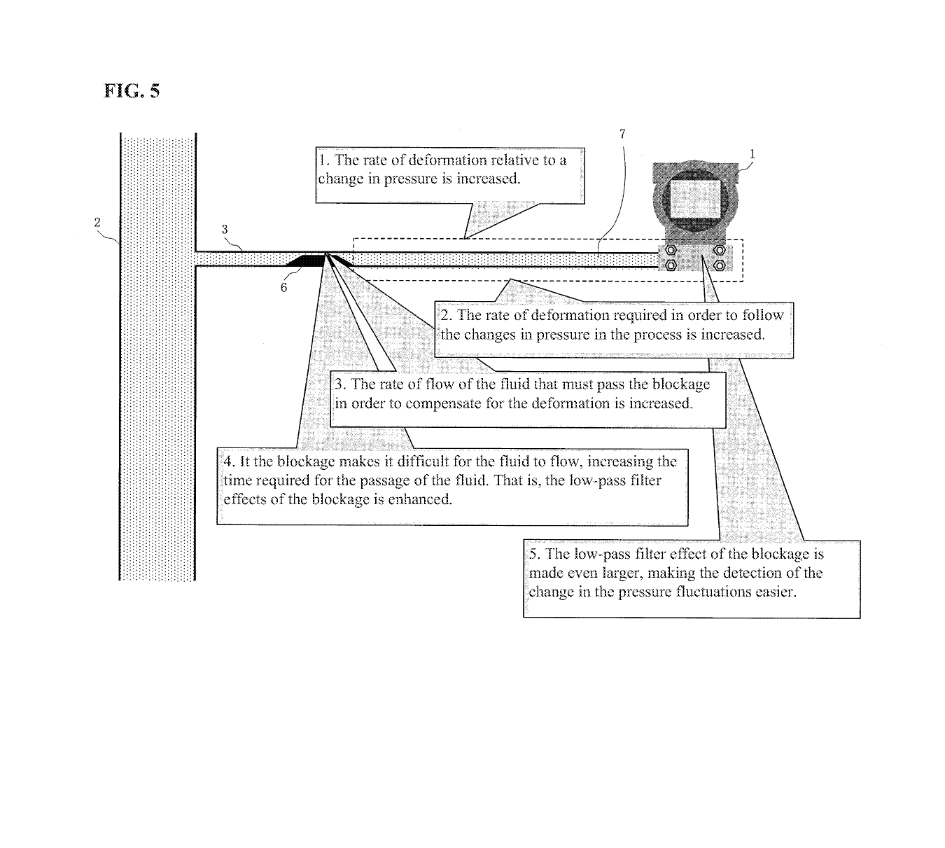

On the other hand, because, of course, it is difficult for the fluid to flow across the blockage (occlusion) 6, the cancellation of the pressure difference thereacross takes some time. This time is longer the greater the amount of fluid required for canceling the pressure differential, that is, is longer the greater the ease with which the aforementioned deforming elements deform. The result is that the greater the rate of deformation, the more difficult it is for the pressure on the detecting end side to track fast variations in pressure on the process pipe side (high-frequency pressure variations), thus increasing the low-pass filter effect of the blockage. (See FIG. 5.) Increasing the low-pass filter effect of the blockage (occlusion) 6 means that the change in the pressure fluctuations can be detected more easily.

Given the principal set forth above, the detection of changes in the pressure fluctuations can be made easier through intentionally increasing the rate of deformation of the deforming elements that are further to the detecting end side than the blockage (occlusion) 6, or further adding elements, or the like, that are easily deformed, to thereby increase the sensitivity of the pressure guiding tube blockage detection, making it possible to detect a blockage in the pressure guiding tube at an earlier point in time.

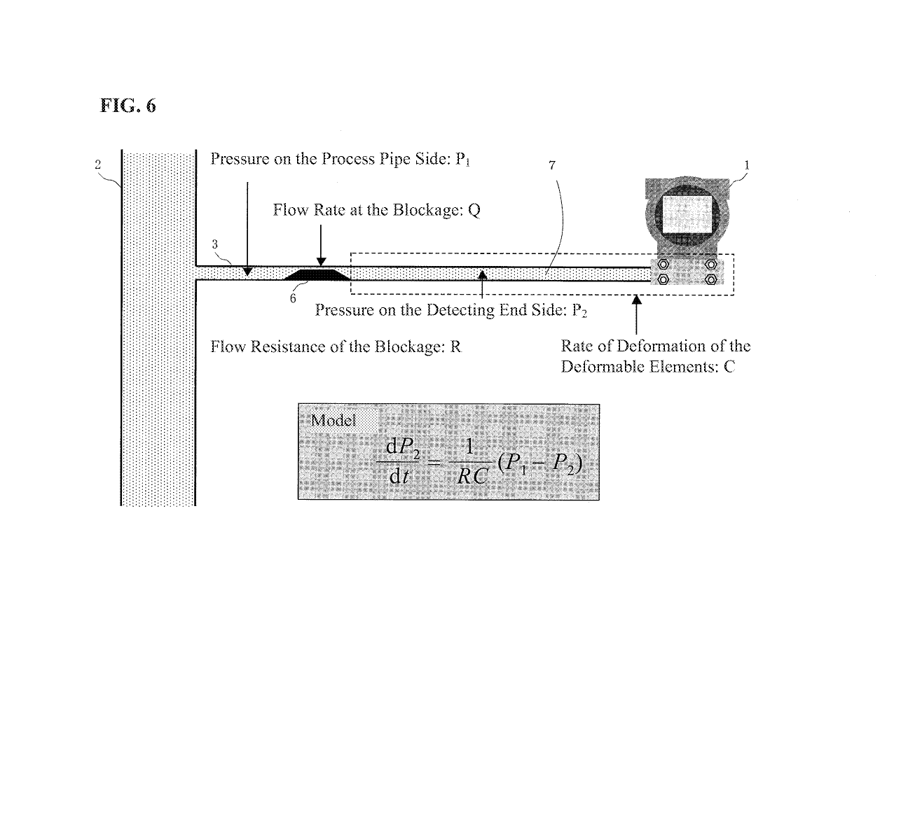

A more theoretical explanation is given next using a model of the low-pass filter described above. (See FIG. 6.) Equations for characterizing the occlusion and the deforming elements is derived first. In the below, the pressure on the process pipe side, when viewed from the blockage (occlusion) 6 is represented by P₁, and, similarly, the pressure on the detecting end side is represented by P₂, and the rate of flow past the blockage (occlusion) 6 is represented by Q. For this flow rate, the direction of flow from the process pipe side to the detecting end side is defined as positive, so when flowing backward, is represented by a negative number. While in reality the pressure propagation characteristics from P₁ to P₂ should be modeled as a distributed parameter system, for ease in the explanation below the explanation is for simple modeling with lumped- parameter approximation.

The characteristics of the occlusion are modeled by the equation below. In the below, the flow path resistance is defined as R. Note that if the flow across the blockage (occlusion) 6 is laminar, then it is possible to derive an equation that is identical to the following equation from the Hagen-Poiseuille equation. Note that t in this equation represents time.

[Equation 1]

P₁(t)−P₂(t)=RQ(t) (1)

The rate of deformation relative to the pressure on the deforming elements is modeled as shown in the equation below. In the below, the rate of deformation is indicated by this C.

$$\begin{matrix}[ Equation 2 ] & \\ C \frac{d {P}_{2}}{d t} = Q ( t ) & ( 2 )\end{matrix}$$

Here larger values for the rate of deformation C mean greater deformation of the deforming elements when there is a change in the pressure P₂. The deformation of these deforming elements causes fluid of a volume equal to the magnitude of this deformation to flow in or flow out from the blockage (occlusion) 6, and thus the magnitude thereof will match the Q in Equation (1). Combining Equation (1) with Equation (2) produces the following relationship:

$$\begin{matrix}[ Equation 3 ] & \\ \frac{d {P}_{2}}{d t} = \frac{1}{RC} ( {P}_{1} ( t ) - {P}_{2} ( t ) ) & ( 3 )\end{matrix}$$

It can be understood from this equation that the propagation of pressure from P₁ to P₂ is a low-pass filter with a time constant RC. That is, the greater the C, the greater the time constant RC, and the greater the high-frequency attenuation effect of the filter. The result is easier detection of the changes in the pressure fluctuations, increasing the sensitivity of the pressure guiding tube blockage detection.

Note that while the low-pass filter effect in relation to the pressure propagation is increased by increasing C, there is essentially no effect when the pressure guiding tube is operating properly. This is because the time constant in a low-pass filter is the product of R and C, and thus if R is adequately small, through the pressure guiding tube operating properly, then the low-pass filter effect is not significant. Consequently, even if C is made larger, still there is no effect on the pressure measurement when operating properly (unless C is caused to be extremely large).

Example Wherein the Rate of Deformation of the Fluid Is Increased (for a Compressible Fluid)

In an example, a pressure guiding tube, a connecting tube that connects to the pressure guiding tube, and a fluid that flows in these tubes are defined as a tube system (deformable elements), and a vessel that is filled with the fluid that flows in through the connecting tube is provided as a deformation rate increasing device for increasing the rate of deformation C relative to the change in pressure in the tube system.

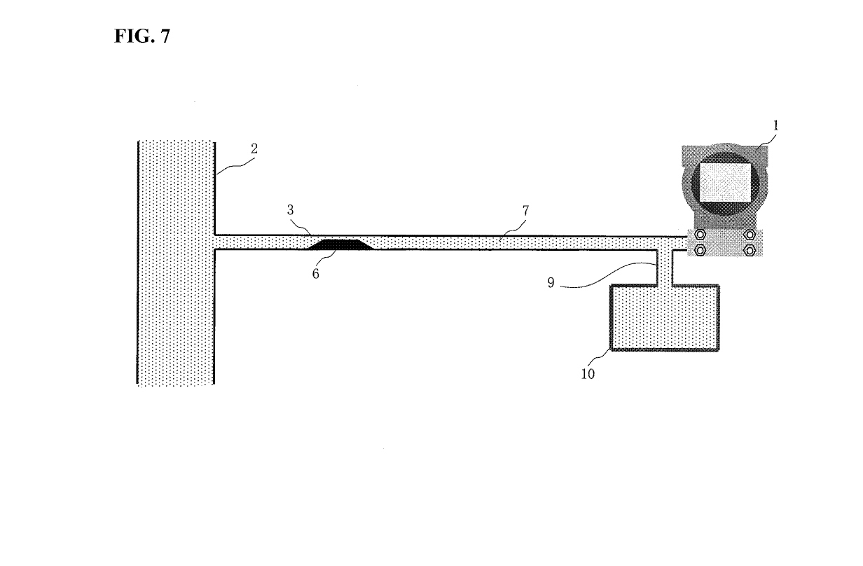

An example is illustrated in FIG. 7. In this first example of the first form of embodiment, a tank-type vessel 10 is connected through a connecting tube 9 to a specific location in the pressure guiding tube 3 between the process pipe 2 and the pressure transmitter 1. The fluid 7 within the pressure guiding tube 3 is filled into the vessel 10 through the connecting tube 9.

The provision of this vessel 10 increases the volume of the fluid 7 that is beyond connecting point of pressure guiding tube 3 and the vessel 10 (that is, on the detecting end side). If there is a blockage (occlusion) 6 on the process pipe side of this connecting point, then the volume of the fluid 7 that is behind the blockage (occlusion) 6 (on the detecting end side) is larger than in the case wherein this vessel 10 has not been added.

Because the rate of deformation of the fluid 7 itself relative to the change in pressure is proportional to the volume of the fluid 7, the addition of the vessel 10, that is, the increase in the rate of deformation of the fluid 7 relative to the change in pressure, produces the effect of increasing the rate of deformation C of the tube system relative to the change in pressure. The result is that the change in the pressure fluctuations can be detected more easily, increasing the sensitivity of the pressure guiding tube blockage detection.

In terms of the volume of the vessel that is added, in order to obtain an adequate effect, the volume of the vessel that is added preferably is at least 10 times the volume of the fluid that fills the tube system prior to the addition of the vessel. If the flow across the blockage is a laminar flow, then the flow resistance is inversely proportional to the fourth power of the diameter of the occluded part, proportional to the square of the cross- sectional area thereof (derived from the Hagen-Poiseuille equation).

For example, when the C in Equation (3) is doubled, then the same low-pass filter effect will be obtained as halving the R. However, that which corresponds to halving the R is a diameter of 2^{1/4} times (approximately 1.2 times), with a cross-sectional area of 2^{1/2} times (approximately 1.4 times), so even though it can be said that this facilitates the detection of a blockage, the amount of improvement is not very much. Back-calculating, in order to obtain a low-pass filter effect that is the same as even doubling the diameter of the occlusion, R would have to be multiplied by 1/16, so it is necessary to multiply C by 16. In consideration of the above, if the value for C is not at least 10 times that which it was originally, then the improved effect that is obtained cannot be considered to be sufficient. Given this, because in the present example, the value of C increases proportionately with the volume of the vessel that is added, it is necessary to increase by this same amount the volume of the vessel that is added.

In this example, the location of the connection between the pressure guiding tube 3 and the vessel 10 is important. This is because there is no effect on increasing the rate of deformation for a blockage that is further towards the detecting end side than this point of connection (because whether or not there is a vessel 10 would have no effect on the volume of the fluid on the detecting end side when viewed from the blockage (occlusion) 6). Consequently, most preferably the vessel 10 is connected to near the connecting point between the pressure transmitter 1 and the pressure guiding tube 3, as illustrated in FIG. 7. On the other hand, there is a high probability that no effect would be obtained if the position were near to the connecting point between the process pipe 2 and the pressure guiding tube 3.

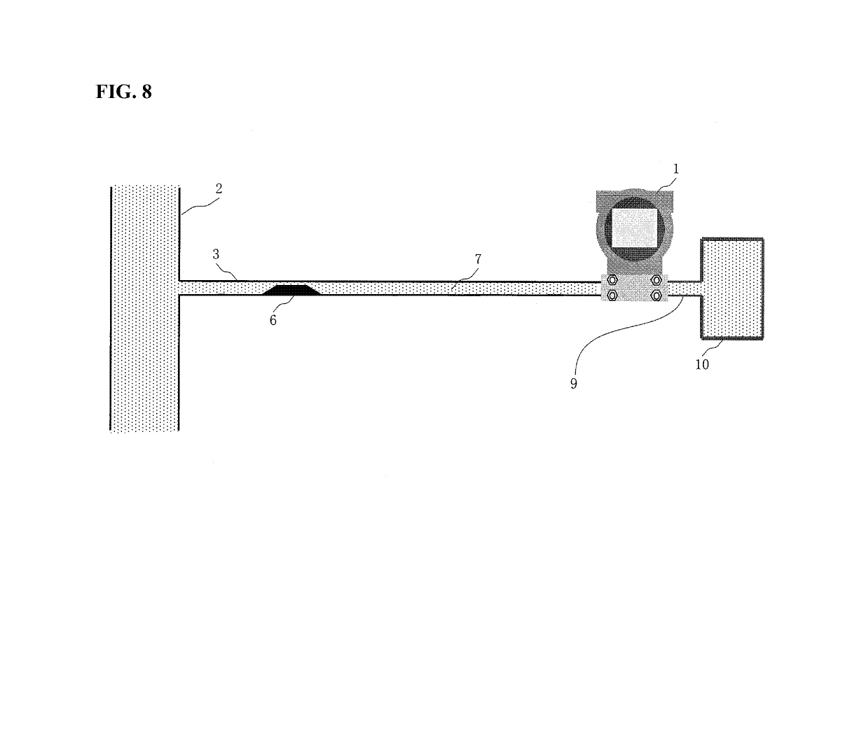

Another example is illustrated in FIG. 8. In this example, the vessel 10 is connected through a connecting tube 9 through an extension of the pipe further beyond the pressure transmitter 1. Because there is a drain plug in the pressure transmitter 1, this drain plug can be used for connecting the vessel 10 further back from the detecting end.

Note that it is primarily when the fluid 7 is a compressible fluid that this example is effective. If the fluid 7 is a non-compressible fluid, then there is essentially no deformation of the fluid itself, even when there is a change in pressure, so that even if there were an effect, it would be small. Note that the value in the following equation may be compared to the rate of deformation of the other deformable elements (for example, that of the pressure bearing surfaces 8 of the pressure transmitter 1) (corresponding to C in Equation 2)) in order to estimate whether or not there is an effect:

V/K (4)

Here V is the volume of the vessel 10 that is added, and K is the volumetric modulus of elasticity of the fluid 7. If this value is sufficiently large when compared to the rate of deformation of the other deformable elements (for example, that of the pressure bearing surfaces 8 of the pressure transmitter 1), then one can anticipate an effect through the addition of this element. On the other hand, if about the same or much smaller, then one can predict that the effect of the addition would be extremely small or likely to be absent altogether. In this case, it would be the example, described below, that would be effective.

This example has the benefit of producing the desired effect without having to make any modifications to the pressure transmitter 1 itself, which has already been installed, and the benefit of minimizing the changes in the measurement system.

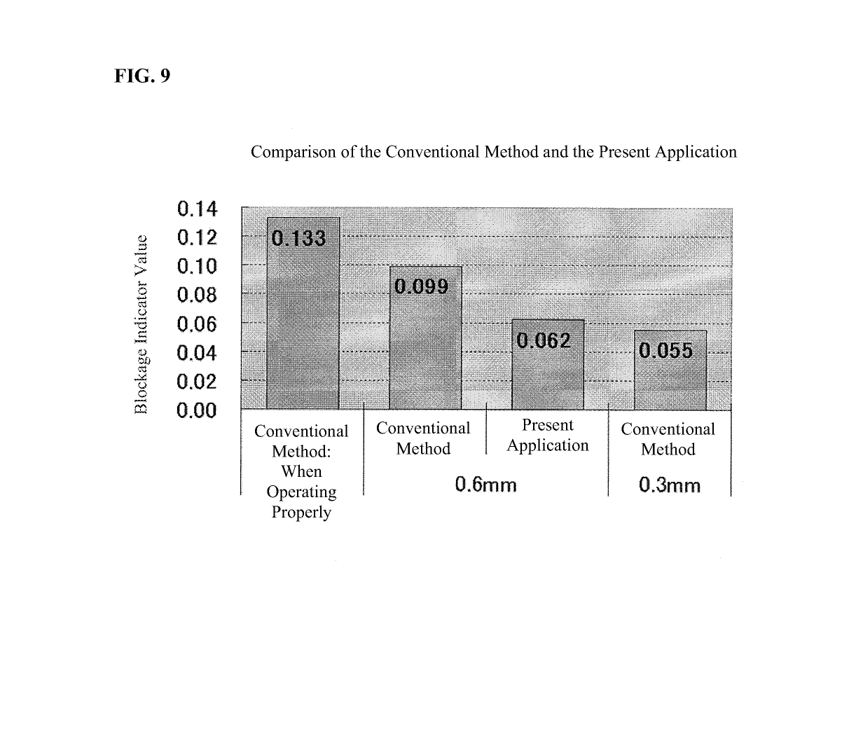

FIG. 9 shows a comparison of the blockage indicator value in the case wherein the example is implemented, versus the conventional method. The graph shows the blockage indicator value based on the method set forth below. This indicator value falls when the pressure guiding tube becomes blocked, making it possible to detect a blockage through comparing with the indicator value from the time of proper operation. Note that the indicator value at the time of proper operation (that is, in a state wherein there is no blockage) was 0.133.

When No Vessel 10 Was Provided (Conventional Method)

When a dummy occlusion with a diameter of 0.3 mm was inserted into the pressure guiding tube part, the blockage indicator value dropped to 0.055, which was less than one half of the normal value. On the other hand, this was 0.099 when a dummy occlusion of a diameter of 0.6 mm was inserted, the change in the indicator value remained small.

When a Vessel 10 Is Provided (Present Application)

Given this, a vessel 10 was added near the far end of the pressure guiding tube 3, as illustrated in FIG. 7, in order to increase the volume between the dummy occlusion and the pressure transmitter 1. When this was done, the indicator value when a dummy occlusion of a diameter of 0.6 mm was inserted went to 0.062.

In this way, the use of the method shown in the above example causes the blockage indicator value to change even with a smaller degree of blockage, that is, increases the pressure guiding tube blockage detection sensitivity, making it possible to detect a failure in the pressure guiding tube at an earlier point in time.

### Reference Example 1

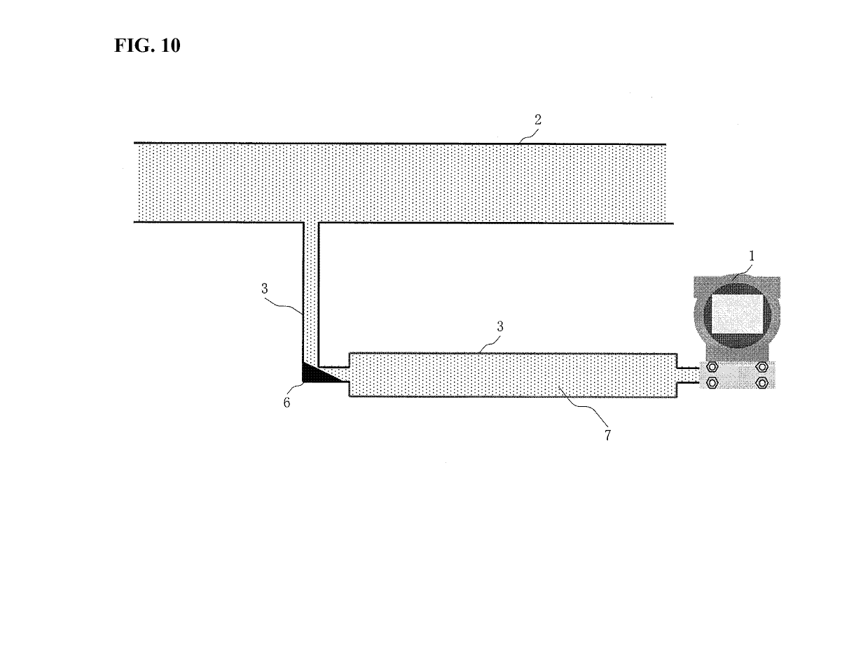

Note that while in the example a vessel 10 was provided as the deformation rate increasing device, it is possible to obtain the same effect as in the first form of embodiment through instead increasing the volume of the fluid 7 between the blockage (occlusion) 6 and the pressure transmitter 1 by increasing the diameter of a portion or the entirety of the pressure guiding tube 3, as illustrated in FIG. 10.

In FIG. 10, a corner portion of the pressure guiding tube 3 wherein it bends in an L-shape is a location that is prone to blockages, and the diameter of the pressure guiding tube 3 beyond this corner portion is increased. If, for example, this diameter were to be tripled, then the volume occupied by the fluid, and the rate of deformation thereof, would be multiplied by a factor of nine. As with the first form of embodiment, this reference example 1 is a method that is effective primarily for a compressible fluid. Moreover, the magnitude of the effect depends on the location of the blockage (occlusion) 6.

Example Wherein the Rate of Deformation of the Surfaces Contacted by the Fluid Is Increased (for a Non-compressible Fluid)

In this example, a pressure guiding tube, a connecting tube that connects to the pressure guiding tube, and the fluid that flows in these tubes are defined as the tube system (the deformable elements), and a diaphragm that contacts the fluid that is introduced through the connecting tube is provided as the deformation rate increasing device for increasing the rate of deformation C of the tube system relative to a change in pressure.

Note that in this example, the diaphragm that is provided as the deformation rate increasing device increases the rate of deformation, relative to the change in pressure, slightly more than the rate of deformation of the pressure bearing surfaces 8 within the pressure transmitter 1. The rate of deformation of this diaphragm is described below.

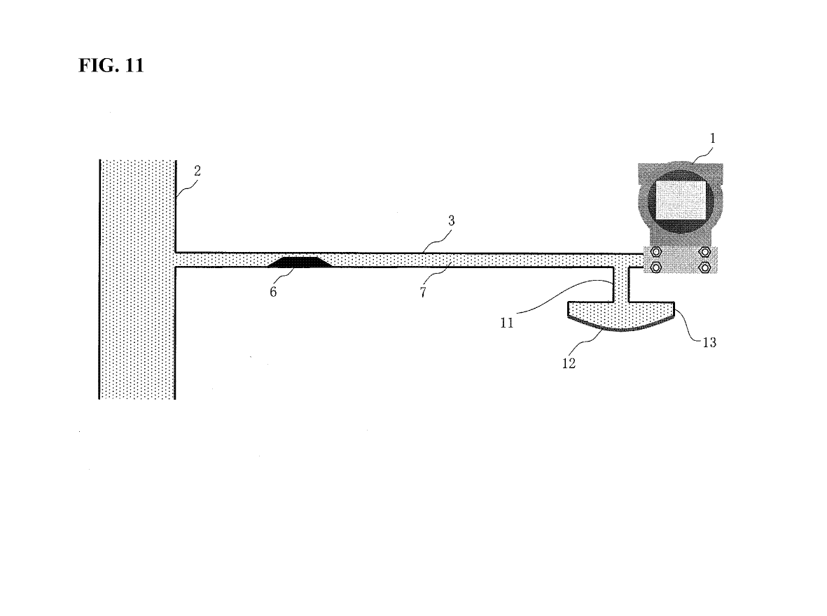

Another example is illustrated in FIG. 11. In this example, a part 13 that has a diaphragm 12 is connected through a connecting tube 11 to a specific location of the pressure guiding tube 3 between the process pipe 2 and the pressure transmitter 1. In this part 13, the fluid 7 within the pressure guiding tube 3 flows through the connecting tube 11 into a space that is blocked by the diaphragm 12. Moreover, the rate of deformation of the diaphragm 12 relative to a change in pressure is increased as described below.

The provision of this part 13 causes the fluid 7 to contact the diaphragm 12, so that the diaphragm 12 deforms through a change in pressure within the pressure guiding tube 3. Doing this, that is, increasing the rate of deformation, relative to a change in pressure, of the diaphragm 12 that contacts the fluid 7, produces the effect of increasing the rate of deformation C of the tube system relative to a change in pressure, which, as a result, facilitates the detection of a change in the pressure fluctuations, thereby increasing the sensitivity of the pressure guiding tube blockage detection.

In this example, the location of the connection between the pressure guiding tube 3 and the parts 13 that has the diaphragm 12 is important. This is because there would be no effect if the diaphragm 12 that is added is not further towards the detecting end side, when viewed from the blockage (occlusion) 6. Consequently, most preferably the part 13 that has the diaphragm 12 is connected to near the connecting point between the pressure transmitter 1 and the pressure guiding tube 3, as illustrated in FIG. 11. On the other hand, there is a high probability that no effect is obtained if the position were near to the connecting point between the process pipe 2 and the pressure guiding tube 3.

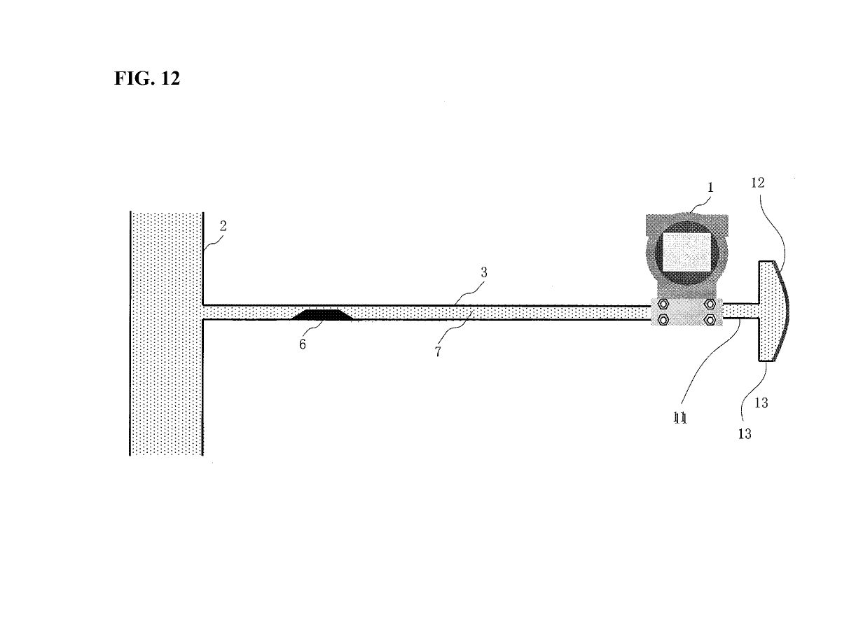

A further example is illustrated in FIG. 12. In this example, the part 13 that has the diaphragm 12 is connected through a connecting tube 11 through an extension of the pipe further beyond the pressure transmitter 1. Because there is a drain plug in the pressure transmitter 1, this drain plug can be used for connecting the part 13 further back from the detecting end.

In order to obtain an adequate effect, preferably the rate of deformation of the added diaphragm 12 is at least 10 times the rate of deformation pressure bearing surfaces 8 of the pressure transmitter 1. The reason for this is as explained in the paragraphs above. Note that it is primarily for the case wherein the fluid 7 is a non-compressible fluid that this example is effective. When the fluid 7 is a compressible fluid, then the change in volume of the fluid itself in response to a change in pressure is large, typically exceeding the rate of deformation of the diaphragm 12. In this case, it is the example described above that would be effective.

This example also has the benefit of producing the desired effect without having to make any modifications to the pressure transmitter 1 itself, which has already been installed, and the benefit of minimizing the changes in the measurement system.

### Reference Example 2

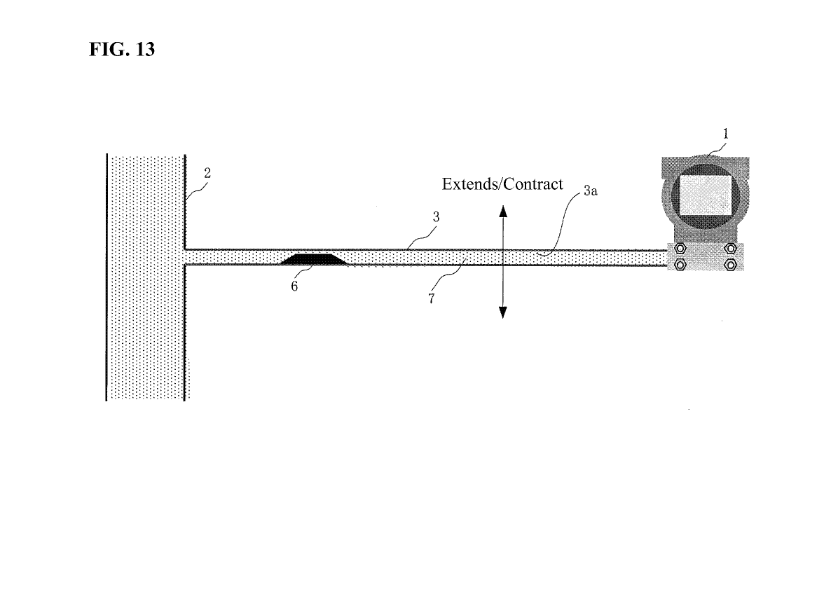

Note that while in this example, the provision of a part 13 that has a diaphragm 12 was used as the deformation rate increasing device; however, the same effect as in the above example can be obtained through structuring the pressure guiding tube 3 from materials that are easily deformed by a change in pressure, in the structure illustrated in FIG. 13, for example.

When there is a change in the pressure of the fluid within the pressure guiding tube 3, the pressure guiding tube 3 expands or contracts in the direction of the diameter thereof. That is, the higher the pressure, the larger the diameter, and the lower the pressure, the smaller. Typically the pressure guiding tube 3 is a pipe that is made out of metal. Moreover, usually the amount of expansion or contraction relative to a change in pressure is small. Given this, it is possible to increase the rate of deformation of the pressure guiding tube 3 itself through using, for the material for the pressure guiding tube 3, a plastic or soft metal that the forms more easily, or through making the thickness of the tube walls 3a of the pressure guiding tube 3 thinner. The result is that the changes in the pressure fluctuations can be detected more easily, making it possible to increase the sensitivity of the pressure guiding tube blockage detection.

In order to estimate whether or not there is an effect, the rate of deformation of the other deformable elements (such as the pressure bearing surfaces 8 of the pressure transmitter 1, the fluid 7 within the pressure guiding tube 3, and the like) may be compared to the rate of deformation of the pressure guiding tube 3. A large defect can be anticipated if the rate of deformation of the pressure guiding tube 3 is larger than about 10 times that of the rate of deformation of the other deformable elements. On the other hand, if held to no more than the rate of deformation of the other deformable elements, essentially no effect can be anticipated. While there may be some degree of effect therebetween, an adequate effect cannot be anticipated.

Note that the use of easily deformable materials or structures for the pressure guiding tube 3 has the risk of reducing the safety of the process. Thus these manipulations must be performed within a range permitted by the process and by the specifications thereof.

Moreover, there is one point of caution in this Reference Example 2. That is, the effect varies somewhat depending on the location of the blockage (occlusion) 6. Specifically, the closer the blockage (occlusion) 6 is to the process pipe side, the greater the effect, and the closer to the detecting end, the less the effect. Moreover, there is no effect at all if the connecting part between the pressure transmitter 1 and the pressure guiding tube 3 is blocked. This is because the contribution to the effect of facilitating detection is only through the pressure guiding tube 3 that is between the blockage (occlusion) 6 and the pressure transmitter 1.

Moreover, when it comes to one or the other, this Reference Example 2 is also a method intended for non-compressible fluids. Because the rate of deformation of a compressible fluid is typically substantially larger than the rate of deformation of the pressure guiding tube, the application of the method in this Reference Example 2 to a compressible fluid cannot be anticipated to have much of an effect.

Moreover, while explanations were given above for examples, the present invention is not limited only to these examples. For example, certain examples may be used together, or deformation rate increasing device structure other than those described above may be added.

Moreover, while in the examples described above the explanation was for an example of application to a pressure measuring system using a pressure transmitter 1, it may also be applied similarly to a differential pressure measuring system using a differential pressure transmitter 4 (shown in FIG. 15). In the differential pressure system, the difference between a fluid pressure that is introduced through a pressure guiding tube 3-1 and a pressure of a fluid that is introduced through a pressure guiding tube 3-2 is detected by a differential pressure transmitter 4, but, in the same manner as in the first and second forms of embodiment, the vessel 10 or the part 13 that has the diaphragm 12 may be connected, as a deformation rate increasing device, either to both the pressure guiding tube 3-1 and the pressure guiding tube 3-2, or to either the pressure guiding-3-1 or the pressure guiding tube 3-2.

Moreover, while the examples of the present invention are envisioned primarily for use as a method for detecting blockages in pressure guiding tubes through the use of the pressure fluctuations in the fluid, there is no limitation thereto. That is, the examples of the present invention are effective also as means for detecting other blockages, insofar as the detection uses the phenomenon of the blockage (occlusion) in the pressure guiding tube acting as a low-pass filter for the propagation of pressure within the pipe.

For example, Japanese Patent 3147275 (“JP '275”) and Japanese Unexamined Patent Application Publication 2007-47012 (“JP '012”) disclose technologies for detecting blockages in pressure guiding tubes through the response of pressures or differential pressures to signals wherein step-shaped waveforms are superimposed onto operating signals for control valves for the process pipes to which the transmitters are connected.

These technologies use the change in the pressure response waveforms because the blockages within the pressure guiding tubes act as low-pass filters when the changes in the pressures or differential pressures that are produced through the operation of the control valves propagate to the transmitters. The application of the present invention to these means as well increase the change in response due to the blockage, thereby increasing the sensitivity of the detection of blockages in the pressure guiding tubes, making it possible to detect blockages in the pressure guiding tubes at earlier points in time.

The pressure guiding tube blockage detecting system according to the examples of the present invention can be used, as a pressure guiding tube blockage detecting system for detecting blockages that occur in pressure guiding tubes that branch from process pipes, in pressure measuring systems that use pressure transmitters or in differential pressure measuring systems that use differential pressure transmitters.

1. A pressure guiding tube blockage detecting system detecting a blockage in a pressure guiding tube that branches from a process pipe, comprising:
a deformation rate increasing device increasing a rate of deformation of a tube system relative to a change in pressure, wherein a pressure guiding tube, a connecting tube that is connected to a pressure guiding tube, and a fluid that flows in these tubes are defined as the tube system.

2. The pressure guiding tube blockage detecting system as set forth in claim 1, wherein:
the fluid is a compressible fluid; and
the deformation rate increasing device increases the rate of deformation, relative to a change in pressure, of the fluid in the tube system.

3. The pressure guiding tube blockage detecting system as set forth in claim 1, wherein:
the fluid is a non-compressible fluid; and
the deformation rate increasing device increases the rate of deformation, relative to a change in pressure, of a surface that contacts the fluid within the tube system.

4. The pressure guiding tube blockage detecting system as set forth in claim 2, wherein:
the deformation rate increasing device is a vessel filled with fluid that is introduced through the connecting tube.

5. The pressure guiding tube blockage detecting system as set forth in claim 3, wherein:
the deformation rate increasing device is a diaphragm that contacts a fluid that is introduced through the connecting tube.

6. A pressure guiding tube blockage detecting method for detecting a blockage in a pressure guiding tube that branches from a process pipe, comprising the step of:
increasing the rate of deformation, relative to a change in pressure, of a tube system, where the pressure guiding tube, a connecting tube that connects to the pressure guiding tube, and a fluid that flows in these tubes is defined as the tube system.

7. The pressure guiding tube blockage detecting method as set forth in claim 6, wherein:
the fluid is a compressible fluid; and
the rate of deformation relative to a change in pressure of the fluid in the tube system is increased.

8. The pressure guiding tube blockage detecting method as set forth in claim 6, wherein:
the fluid is a non-compressible fluid; and
the rate of deformation relative to a change in pressure of a surface that contacts the fluid in the tube system is increased.

9. The pressure guiding tube blockage detecting method as set forth in claim 7, wherein:
a vessel that is filled with fluid that is introduced through the connecting tube is provided; and
the rate of deformation relative to a change in pressure of the fluid in the tube system is increased by the vessel.

10. The pressure guiding tube blockage detecting method as set forth in claim 8, wherein:
a diaphragm that contacts fluid that is introduced through the connecting tube is provided; and
the rate of deformation, relative to a change in pressure, of the surface that contacts the fluid in the tube system is increased by the diaphragm.
